(19) United States
(12) Patent Application Publication
(10) Pub. No.: US 2023/0278571 A1
(43) Pub. Date: Sep. 7, 2023

(54) PASSENGER ALERTING DEVICE

(71) Applicant: John Mallo, Reedsburg, WI (US)

(72) Inventor: John Mallo, Reedsburg, WI (US)

(21) Appl. No.: 17/687,424

(22) Filed: Mar. 4, 2022

(51) Int. Cl. B60W 50/14; B60W 40/08; B60N 2/00

(52) U.S. Cl. CPC B60W 50/14; B60W 40/08; B60N 2/002; B60W 2050/143; B60W 2050/146; B60W 2040/0881; B60W 2420/22; B60W 2540/221

(57) ABSTRACT

The present invention is directed to a passenger alerting device. The passenger alerting device includes a weight sensor configured for placement on a passenger seat. The device further includes an alarm panel. The alarm panel is in communication with the weight sensor in such a manner that an audible alarm will become energized in the event that the passenger vehicle is placed in park while a passenger may have been left behind. The device is useful for detecting the presence of passengers, particularly young students, and alerting to their presence so they will not be left behind.

### FIELD OF THE INVENTION

This invention relates to vehicle safety systems. More particularly, it relates to a device and system for monitoring the presence of passengers in a vehicle.

### BACKGROUND

Occupant detection devices can be used to enable or disable a safety restraint device, such as an airbag, or to determine how many occupants are present in a vehicle or a room. These devices can be used to detect the absence of an occupant in the passenger seat of a vehicle, and thereby disable the deployment of the passenger's airbag. The number of occupants in a vehicle may also be monitored prior to an accident in order to provide a telematic unit, such as Onstar®, with an occupant count in order to dispatch an adequate amount of emergency response. Having an accurate occupant count prior to an accident can also help emergency response personnel to determine if one or several of the occupants may have been ejected from the vehicle during the collision. In the transportation industry, occupant presence detection devices can provide a quickly count of the number of passengers in a plane, train or bus. They can also show which seats are occupied and which are not. This can also apply to theaters or halls where it is desirable to know how many occupants are present and where newly arriving customers can find empty seats.

Vehicles such as buses and trains are examples of passenger carrying vehicles. These vehicles tend to make stops at multiple passenger pick-up locations to permit passengers to embark and disembark from the vehicle. The vehicles tend to visit these locations along vehicle journeys according to a timetable that indicates when the vehicle should reach each of the locations. It is usual for an amount of time to be allocated in the timetable for the duration that is required to set-down and pick-up passengers from that stop. For the vehicle to complete its journey in accordance with the timetable, it is desirable that the amount of time the vehicle spends at each stop to be, at worst, equal to the time allocated in the timetable for this stop period. Further, public transportation for schools presents additional concerns. Often times a school bus may be transporting students as young as 5 years old and as a result, it is imperative that the bus driver always remain informed as to the correct passenger count to avoid miscounts and mistakes of human error.

Accordingly, and in light of the foregoing, there exists a need for a means of determining accurate passenger counts so that people do not get left behind. It would therefore be desirable for a device that easily and automatically provides information and notifications as to the presence of passengers on a vehicle.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side view of a school bus 15, equipped with the passenger alerting device 10, according to the preferred embodiment of the present invention;

FIG. 2 is a perspective view a passenger seat 20, equipped with a weight sensor 25, as used with the passenger alerting device 10, according to the preferred embodiment of the present invention;

FIG. 3 is a sectional view of the seat cushion 60, as seen along a line I-I, as shown in FIG. 1, according to the preferred embodiment of the present invention;

FIG. 4 is a front view of the alarm panel 50, as used with the passenger alerting device 10, according to the preferred embodiment of the present invention; and,

FIG. 5 is an electrical block diagram of the passenger alerting device 10, according to the preferred embodiment of the present invention.

### DESCRIPTIVE KEY

10 passenger alerting device
15 school bus
20 passenger seat
25 weight sensor
30 driver's position
35 dash
40 steering wheel
45 driver's seat
50 alarm panel
55 seating position
60 seat cushion
65 seat back
70 support frame
75 sensor array
80 base
85 spring
90 foam padding
95 interconnecting wiring
100 durable covering
105 enclosure
110 power indicator light
115 warning light
120 audible alarm
125 incoming electrical power
130 overcurrent device
135 parking lever switch

### DESCRIPTION OF THE PREFERRED EMBODIMENTS

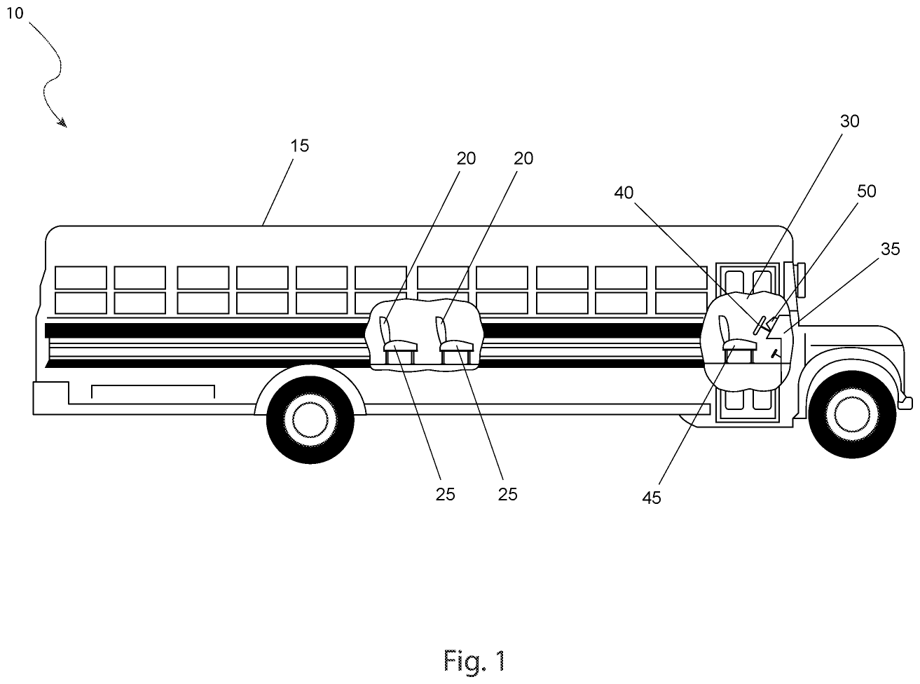

The best mode for carrying out the invention is presented in terms of its preferred embodiment, herein depicted within FIGS. 1 through 5. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

Referring now to FIG. 1, a side view of a school bus 15, equipped with the passenger alerting device 10, according to the preferred embodiment of the present invention is disclosed. The passenger alerting device (herein also described as the “device”) 10, alerts operators of a school bus 15 via an alarm system to alert them of possible passengers that may be left behind (un-egressed passengers) on a school bus 15 at the end of a route. The device 10 is installed upon a school bus 15. The school bus 15 can be of any size (number of passengers) or type, as the device 10 is scalable to accommodate any number of passenger seats 20. Each passenger seat 20 is provided with at least one (1) weight sensor 25. The weight sensor 25 will be capable of sensing a minimum of ten pounds (10 lbs.). Further detail of the operation and configuration of the weight sensor 25 will be described below. The driver's position 30 is provided with a dash 35, a steering wheel 40, and a driver's seat 45 as is customarily expected. The driver's position 30 is also provided with an alarm panel 50. The alarm panel 50 configured to receive a plurality of seat occupancy signals from the passenger seats, the panel constructed to provide an indication when one or more passenger seats is reporting a seat occupancy signal. In a further embodiment of the invention, the alarm panel may be wirelessly connected to the seat occupancy signals.

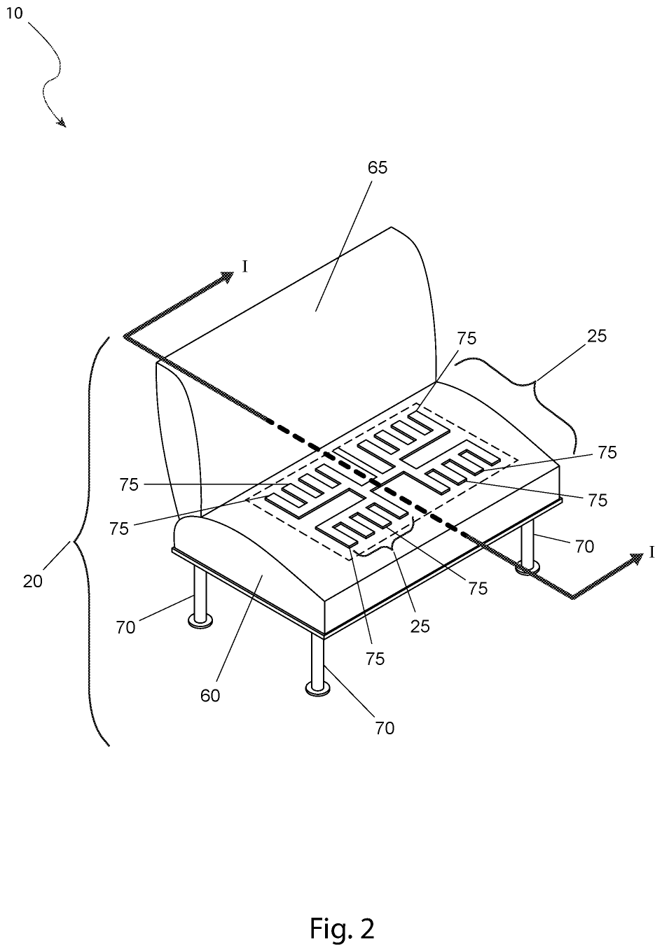

Referring next to FIG. 2, a perspective view of a passenger seat 20, equipped with a weight sensor 25 as used with the device 10, according to the preferred embodiment of the present invention is depicted. The passenger seat 20 can be a single passenger or dual passenger (as shown). Each seating position 55 is provided with its own independent weight sensor 25 configured to report a seat-occupancy signal when the passenger seat is occupied. The passenger seat 20, typical for each and every seating position on the school bus 15 (as shown in FIG. 1), is provided with a seat cushion 60, a seat back 65, and a support frame 70. The configuration of the passenger seat 20 is intended for illustrative purposes only, and other configurations of the seat cushion 60, the seat back 65 and the support frame 70 will be acceptable for use with the teachings of the device 10. As such, the use of other configurations of the passenger seat 20 is not intended to be a limiting factor of the present invention. The weight sensor 25 are provided with multiple sensor arrays 75 that are constructed to detect the weight of a child and a weight greater than 10-15 pounds and such that all of the top surface area of the seat cushion 60 are covered. This feature ensures that any passenger, including the smallest child will activate the device 10 regardless of where he or she sits on the seat cushion 60.

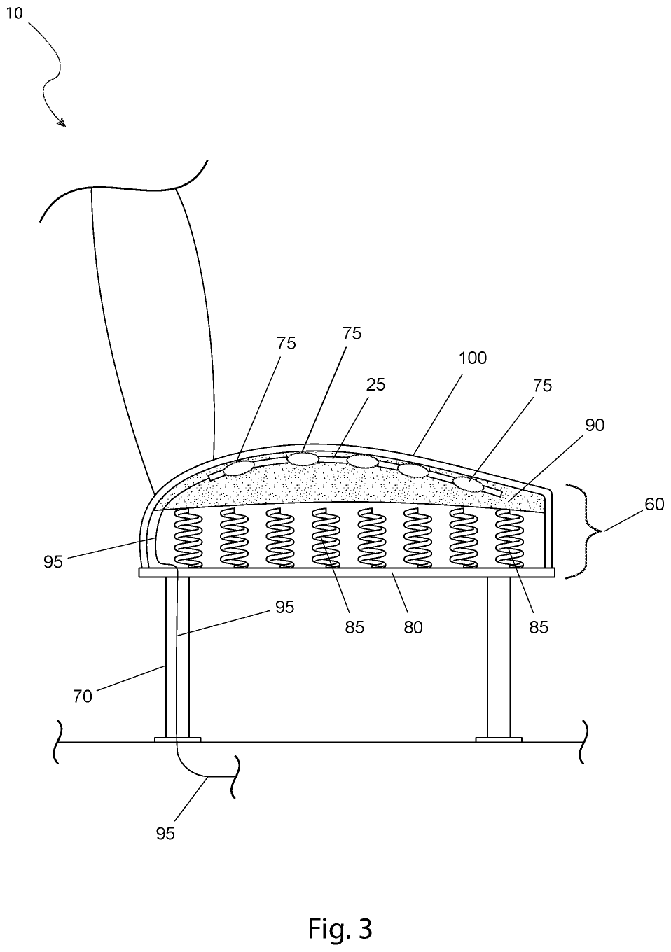

Referring now to FIG. 3, a sectional view of the seat cushion 60, as seen along a line I-I, as shown in FIG. 1, according to the preferred embodiment of the present invention is shown. The seat cushion 60 is envisioned to be comprised of a base 80, which supports multiple springs 85. The springs 85 are then covered with a foam padding 90. The sensor arrays 75 of the weight sensor 25 are located near the top of the foam padding 90 to provide for maximum detection capability. Interconnecting wiring 95 from each weight sensor 25 is routed through the foam padding 90, down the support frame 70 and to the alarm panel 50 (as shown in FIG. 1). The top of the foam padding 90 is provided with a durable covering 100 such as vinyl to provide physical and waterproof protection for both the weight sensor 25 and the foam padding 90.

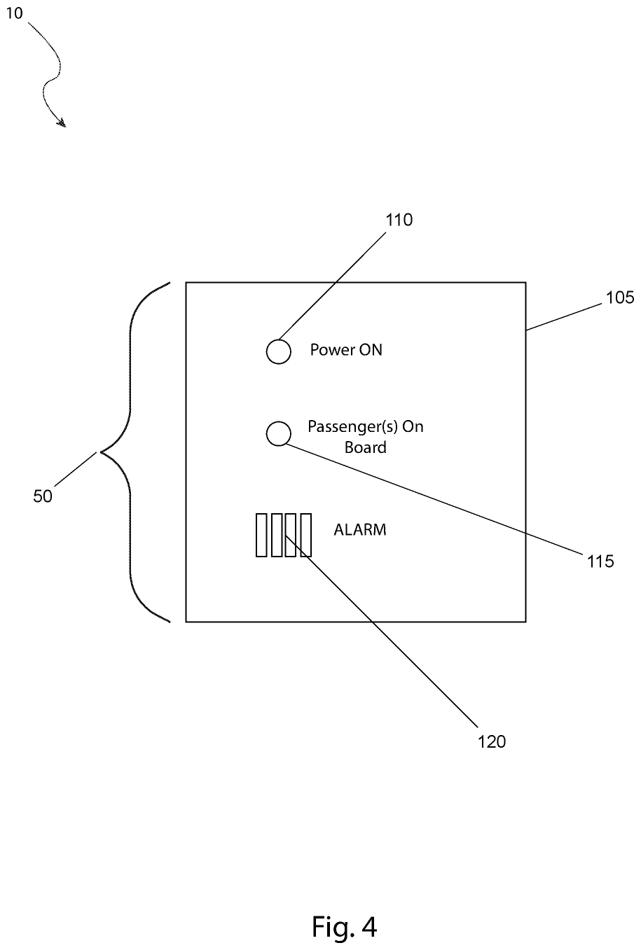

Referring next to FIG. 4, a front view of the alarm panel 50, as used with the device 10, according to the preferred embodiment of the present invention is disclosed. The alarm panel 50 is located near the driver's position 30 (as shown in FIG. 1), such that it is visible to the driver at all times. An enclosure 105 provides physical protection and encloses multiple electrical components. A power indicator light 110 provides indication that the device 10 is energized and operating properly. A warning light 115 provides visual indication that at least one (1) passenger seat 20 is occupied. Such indication during a bus route, while the school bus 15 (as shown in FIG. 1), would not be unusual and likely expected. However, at the end of a bus route, when all passengers are expected to be discharged, if the warning light 115 remains illuminated, the driver can inspect the school bus 15 for the errant passenger. To further increase awareness, should the warning light 115 remain energized, and the school bus 15 be placed in park, an audible alarm 120 will become energized, thus producing a loud warning sound, that cannot be deactivated until the passenger is removed from the passenger seat 20.

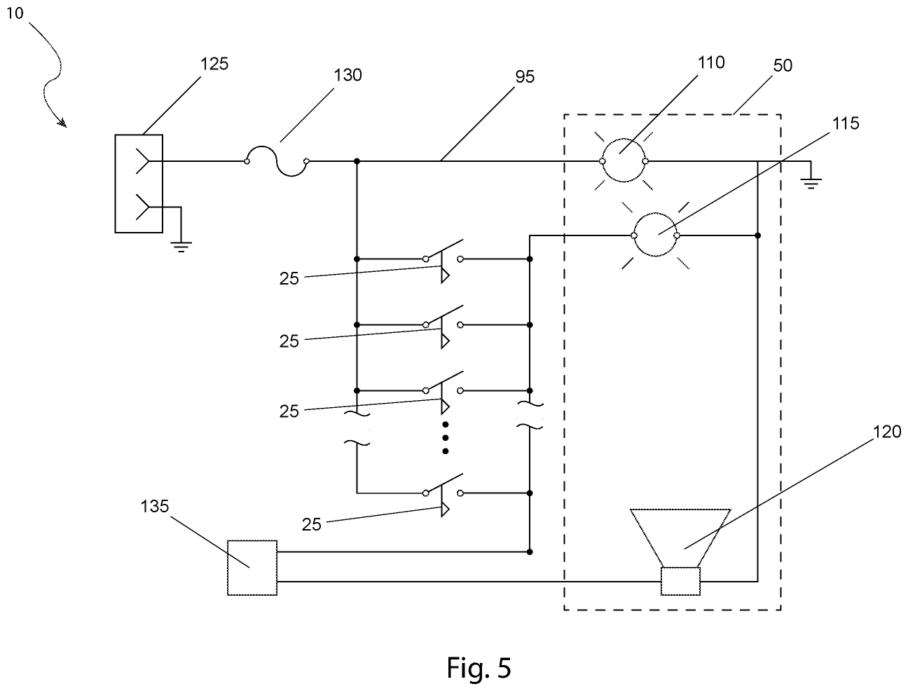

Referring finally to FIG. 5, an electrical block diagram of the device 10, according to the preferred embodiment of the present invention is depicted. Incoming electrical power 125, as supplied by the electrical system of the school bus 15 (as shown in FIG. 1), envisioned to be twelve- or twenty-four-volts direct current (12/24 VDC) is protected by an overcurrent device 130, such as a fuse. Resultant power then energizes the power indicator light 110 as contained within the alarm panel 50. Power is also routed in a parallel path to all weight sensor 25, also connected in a parallel path. Such a connection scheme will allow for illumination of the warning light 115 if one (1) or more weight sensor 25 closes the circuit by a passenger sitting upon them. This intermediate electrical signal, as provided through the interconnecting wiring 95, will also be passed to a parking lever switch 135 in a series connection, thus requiring both the parking lever switch 135 to be closed (as provided in a parked position) as well at least one (1) of the weight sensors (a plurality of weight sensors) 25 to be closed to energize the audible alarm 120.

### 2. Operation of the Preferred Embodiment

The preferred embodiment of the present invention can be utilized by the common user in a simple and effortless manner with little or no training. It is envisioned that the device 10 would be constructed in general accordance with FIG. 1 through FIG. 5. It is envisioned that the device 10 would be provided as a standard or optional equipment on new school bus 15 or could be provided as aftermarket add-on equipment for existing school bus 15. Thus, the device 10 would be procured along with the purchase of a new school bus 15 or could procured in add-on configuration from equipment suppliers, bus manufacturers, mechanical supply houses, mail order and internet supply houses and the like. Special attention would be paid to the quantity of passenger seats 20 and thus number of weight sensor 25 required.

After procurement and prior to utilization, the device 10 would be prepared in the following manner: all of the weight sensor 25 with the individual sensor arrays 75 would be installed on each seat cushion 60 as depicted in FIGS. 2 and 3; the interconnecting wiring 95 from each weight sensor 25 would be routed to the alarm panel 50; incoming electrical power 125 and wiring from the parking lever switch 135 would be routed to the alarm panel 50 as well. Final electrical terminations of the device 10 in accordance with FIG. 5 would be performed. at this point in time, the device 10 is ready for use.

During utilization of the device 10, the following procedure would be initiated: operation of the device 10 is transparent to the user; minimal training on usage and operation would be provided to the driver of the school bus 15. At the end of the route, the warning light 115 would be observed for any remaining occupants of the school bus 15; further alerting would be provided by the audible alarm 120 should the school bus 15 be placed in park. Corrective action to remove the errant passenger and assist them to a safe location would be performed. Upon removal of the errant passengers the warning light 115 will be extinguished and the audible alarm 120 silenced, thus placing the device 10 is a ready state for future use in a repeating and cyclical manner.

These features ensure that passengers such as children will not be accidentally left behind on a school bus 15, thus ensuring their safety at all times, especially in extreme temperature conditions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A system for alerting a bus driver of un-egressed passengers comprising:
a plurality of weight sensors in the bus distributed such that each passenger seat is equipped with a weight sensor, the weight sensor configured to report a seat-occupancy signal when the passenger seat is occupied; and
an alarm panel receiving a plurality of seat occupancy signals from the passenger seats, the panel constructed to provide an indication when one or more passenger seats is reporting a seat occupancy signal.

2. The system of claim 1, wherein the bus is a school bus.

3. The system of claim 1, wherein the indication is a warning light.

4. The system of claim 3, wherein the indication further comprises an audible alarm.

5. The system of claim 4, wherein the audible alarm is only reported if both the warning light is lit, and the bus is placed in park.

6. The system of claim 5, wherein the audible alarm is constructed so that it cannot be deactivated until all of the passenger seats are unoccupied.

7. The system of claim 1, wherein each of the weight sensors comprises multiple arrays of individual force or strain detectors embedded in a seat cushion.

8. The system of claim 7, wherein the seat cushion includes springs, padding and a cover layer, wherein, the arrays are distributed in the seat cushion under the cover layer.

9. The system of claim 7, wherein the arrays are constructed to detect the weight of a child.

10. The system of claim 7, wherein the arrays are constructed to detect any weight greater that 10-15 pounds.

11. The system of claim 1, wherein the seat occupancy signals are reported to the alarm panel via wires.

12. The system of claim 1, wherein the seat occupancy signals are reported to the alarm panel wirelessly.

13. A system for alerting a school bus driver of un-egressed passengers comprising:
a plurality of weight sensors in the school bus distributed such that each passenger seat is equipped with a weight sensor, the weight sensor configured to report a seat-occupancy signal when the passenger seat is occupied;
wherein each of the weight sensors comprises multiple arrays of individual force or strain detectors embedded in a seat cushion; and
an alarm panel receiving a plurality of seat occupancy signals from the passenger seats constructed to provide a visual indication when one or more passenger seats is reporting a seat occupancy signal.

14. The system of claim 13, wherein the visual indication is a light.

15. The system of claim 13, wherein the panel also provides an audible alarm when any passenger seat is occupied, and the bus is placed into park.

16. The system of claim 15, wherein the audible alarm is constructed so that it cannot be deactivated until all of the passenger seats are unoccupied.

17. The system of claim 13, wherein the seat occupancy signals are reported to the alarm panel via wires.

18. A method of preventing accidentally leaving a child behind on a school bus comprising:
equipping each passenger seat on the school bus with a weight detection sensor;
routing outputs of each weight detection sensor to a panel visible to a bus driver;
providing a visual indication on the panel whenever any passenger seat is occupied; and
providing an audible alarm if any passenger seat is occupied, and the bus is placed into park.

19. The method of claim 18, wherein the weight detection sensors are constructed to detect the weight of a small child with a weight ranging between approximately 10 pounds to approximately 15 pounds.

20. The method of claim 18, wherein the routing is via wires from the passenger seats to the panel.
